(19) United States
(12) Patent Application Publication
(10) Pub. No.: US 2024/0393578 A1
(43) Pub. Date: Nov. 28, 2024

(54) ANTI-PEEPING STRUCTURE AND ELECTRONIC DISPLAY DEVICE

(71) Applicant: HKC CORPORATION LIMITED, Shenzhen (CN)

(72) Inventors: Fei Luo, Shenzhen (CN); Lidan Ye, Shenzhen (CN)

(73) Assignee: HKC CORPORATION LIMITED, Shenzhen (CN)

(21) Appl. No.: 18/650,267

(22) Filed: Apr. 30, 2024

(30) Foreign Application Priority Data
May 24, 2023 (CN) 202310591219.2

(51) Int. Cl. G02B 26/00

(52) U.S. Cl. CPC G02B 26/001; G02B 6/0051

(57) ABSTRACT

An anti-peeping structure including: a housing, a plurality of anti-peeping units, and a drive structure; the housing is a transparent structure provided with a cavity; the plurality of anti-peeping units are arranged in the cavity of the housing at intervals; each of the plurality of anti-peeping units is provided with a first side and a second side opposite to the first side, the anti-peeping unit is in an anti-peeping mode when the first side is configured to face a light source, or the anti-peeping unit is in an anti-peeping invalidation mode when the second side is configured to face the light source; the drive structure is configured to drive the plurality of anti-peeping units to rotate in the cavity so as to enable the plurality of anti-peeping units to switch between the anti-peeping mode and the anti-peeping invalidation mode.

### CROSS-REFERENCE TO RELATED APPLICATION

This application claims priority to Chinese Patent Application No. 202310591219.2, filed on May 24, 2023, the content of which is incorporated herein by reference as if fully set forth herein.

### TECHNICAL FIELD

The present application relates to the field of display technology, and more particularly to an anti-peeping structure and an electronic display device.

### BACKGROUND

With the popularization of portable display devices, the anti-peeping technology of electronic display devices has attracted more and more attentions. People hope to protect personal privacy when using electronic display devices in public places.

At present, the electronic display devices with the anti-peeping mode generally have anti-peeping structures arranged therein. When anti-peeping is required, the electronic display device can be set to the anti-peeping mode, however, when the anti-peeping is not required, it is impossible to adjust the electronic display device to flexibly switch the anti-peeping mode to the anti-peeping invalidation mode, which results in extremely inconvenient usage of the electronic display device.

### SUMMARY

An object of an embodiment of the present application is to provide an anti-peeping structure and an electronic display device, so as to solve the technical problem of electronic display devices being unable to flexibly switch between the anti-peeping mode and the anti-peeping invalidation mode in the prior art.

In order to achieve above object, the technical solution adopted in the present application is to provide an anti-peeping structure, which includes a housing, a plurality of anti-peeping units, and a drive structure; the housing is a transparent structure provided with a cavity; the plurality of anti-peeping units are arranged in the cavity of the housing at intervals; each of the plurality of anti-peeping units is provided with a first side and a second side opposite to the first side, the anti-peeping unit is in an anti-peeping mode when the first side is configured to face a light source, and the anti-peeping unit is in an anti-peeping invalidation mode when the second side is configured to face the light source; the drive structure is configured to drive the plurality of anti-peeping units to rotate in the cavity so as to enable the plurality of anti-peeping units to switch between the anti-peeping mode and the anti-peeping invalidation mode.

In a possible implementation, the drive structure is further configured to drive the plurality of anti-peeping units to rotate to make the plurality of anti-peeping units to stay at positions with different anti-peeping angles.

In a possible implementation, the anti-peeping structure includes a plurality of drive structures, and each of the plurality of drive structures is configured to drive one of the plurality of anti-peeping units to rotate; or to drive more than one of the plurality of anti-peeping units continuously distributed to rotate.

In a possible implementation, the drive structure includes a plurality of electric field units, the plurality of electric field units are arranged on the housing and configured to form an electric field in the cavity, and the plurality of electric field units are acted on the plurality of anti-peeping units to drive the plurality of anti-peeping units to rotate.

In a possible implementation, each anti-peeping unit is coated with a positive electrode coating layer and a negative electrode coating layer, the positive electrode coating layer and the negative electrode coating layer are respectively arranged on the first side and the second side; and the positive electrode coating layer and the negative electrode coating layer are symmetrically arranged on both sides of a rotation axis of the anti-peeping unit, respectively.

In a possible implementation, the drive structure includes a plurality of rotating drive members, the plurality of rotating drive members are connected to the plurality of anti-peeping units and configured to drive the plurality of anti-peeping units to rotate.

In a possible implementation, a plurality of shaft rods are arranged in the cavity and spaced in sequence, each of the plurality of shaft rods is distributed with more than one of the plurality of anti-peeping units, and each of the anti-peeping units is rotatably arranged on the shaft rod.

In a possible implementation, each anti-peeping unit includes an anti-peeping film and a diffusion film, the diffusion film is attached to one side of the anti-peeping film, the anti-peeping film is configured to control a visible angle of light within a predetermined range, and the diffusion film is configured to disperse a light emitted into the diffusion film.

The beneficial effect of the anti-peeping structure provided in the present application is that: the anti-peeping structure provided in the embodiment of the present application arranges the anti-peeping units in the housing, and the anti-peeping units are driven to rotate by the drive structure, such that the anti-peeping units can be flexibly switched between the anti-peeping mode and anti-peeping invalidation mode, which is convenient for users to use according to actual needs. In addition, the anti-peeping structure is divided into the plurality of anti-peeping units, such that the length and width dimensions of each anti-peeping unit are greatly reduced, which facilitates the anti-peeping units to flip and rotate in the cavity with a limited thickness to meet the requirement of flexible switching between the anti-peeping mode and the anti-peeping invalidation mode. Further, the present application also enables the anti-peeping structure to have a sufficiently small thickness while being able to flexibly switch between the anti-peeping mode and the anti-peeping invalidation mode.

In another aspect, an electronic display device is provided, which includes the anti-peeping structure described above.

In a possible implementation, the electronic display device further includes a backlight light source and a display module, and the anti-peeping structure is arranged between the backlight light source and the display module.

The beneficial effect of the electronic display device provided in the present application is that: the electronic display device provided in the embodiment of the present application has the anti-peeping structure described above, such that the electronic display device can flexibly switch between the anti-peeping mode and the anti-peeping invalidation mode, and can realize the ultra-thin design while ensuring the anti-peeping function.

### BRIEF DESCRIPTION OF THE DRAWINGS

In order to explain the embodiments of the present invention more clearly, a brief introduction regarding the accompanying drawings that need to be used for describing the embodiments of the present invention or the prior art is given below; it is obvious that the accompanying drawings described as follows are only some embodiments of the present invention, for those skilled in the art, other drawings can also be obtained according to the current drawings on the premise of paying no creative labor.

FIG. 1 is a longitudinal cross-sectional schematic diagram of an anti-peeping structure provided in an embodiment of the present application;

FIG. 2 is a schematic diagram of a partial distribution of anti-peeping units and shaft rods provided in an embodiment of the present application;

FIG. 3 is a structural schematic diagram of the anti-peeping unit in FIG. 1;

FIG. 4 is a structural schematic diagram of the anti-peeping film in FIG. 3; and

FIG. 5 is a cross-sectional schematic diagram of an electronic display device provided in an embodiment of the present application.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component.

In the description of the present application, it needs to be understood that, directions or location relationships indicated by terms such as “length”, “width”, “up”, “down”, “front”, “rear”, “left”, “right”, “vertical”, “horizontal”, “top”, “bottom”, “inside”, “outside”, and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application.

In addition, terms “the first” and “the second” are only used in describe purposes, and should not be considered as indicating or implying any relative importance, or impliedly indicating the number of indicated technical features. As such, technical feature(s) restricted by “the first” or “the second” can explicitly or impliedly comprise one or more such technical feature(s). In the description of the present application, “a plurality of” means two or more, unless there is additional explicit and specific limitation.

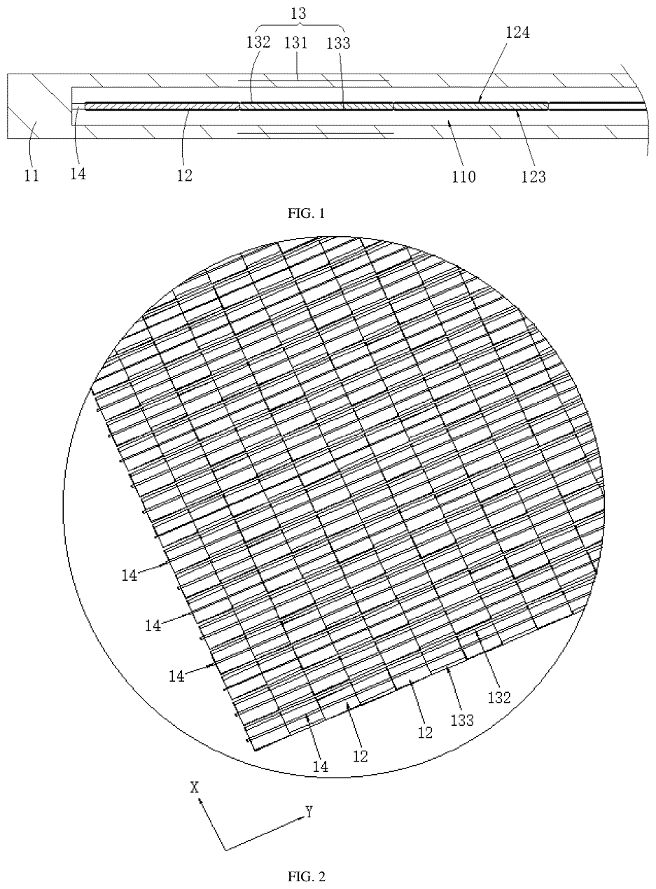

As shown in FIG. 1, the anti-peeping structure 1 provided in the embodiment of the present application is described. The anti-peeping structure 1 is arranged in an electronic display device to achieve the anti-peeping effect. It is understood that in other embodiments of the present application, the anti-peeping structure 1 can also be arranged on a surface of an electronic display device. In the embodiment, the electronic display device can be a monitor, a mobile phone, a tablet computer, etc.

As shown in FIG. 1 and FIG. 2. The anti-peeping structure 1 includes a housing 11, a plurality of anti-peeping units 12 and a drive structure 13; the housing 11 is a transparent structure, and the housing 11 is provided with a cavity 110, and each of the plurality of anti-peeping units 12 is arranged in the cavity 110 of the housing 11 at intervals. Each of the plurality of anti-peeping units 12 is provided with a first side 123 and a second side 124 opposite to the first side 123, when the first side 123 faces the light source, the anti-peeping units 12 are in an anti-peeping mode; when the second side 124 faces the light source, the anti-peeping units 12 are in an anti-peeping invalidation mode. The drive structure 13 is used to drive each anti-peeping unit 12 to rotate in the cavity 110 so that each anti-peeping unit 12 can switch between the anti-peeping mode and the anti-peeping invalidation mode.

As shown in FIG. 2, the number of anti-peeping units 12 is provided with multiple, and the number of the anti-peeping units 12 increases with the increase of a size of the screen of the electronic display device. In fact, when the size of the screen is fixed, the more the number of anti-peeping units 12, the smaller the length and width of a single anti-peeping unit 12, then the more flexible the single anti-peeping unit 12 can be rotated in the limited cavity 110 to achieve the switch between the anti-peeping mode and the anti-peeping invalidation mode. Specifically, the specific number of the anti-peeping units 12 and the specific length and width of a single anti-peeping unit 12 can be determined according to the actual size of the screen of the electronic display device and how thick anti-peeping structure 1 can be accommodated inside the electronic display device.

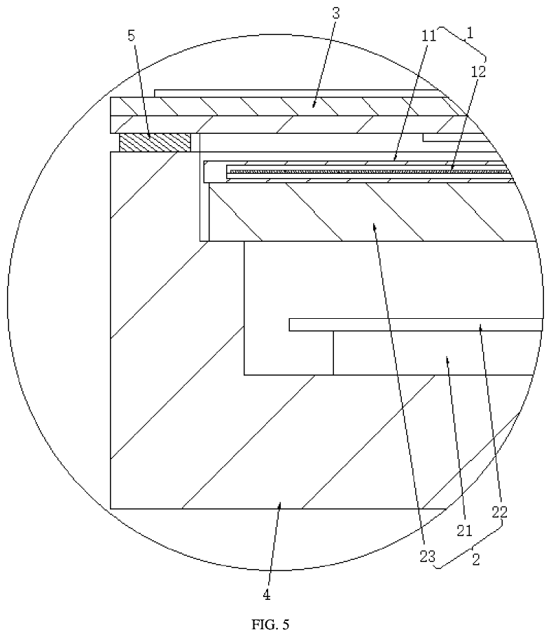

For the anti-peeping mode, taking FIG. 5 as an example, the backlight light source 2 is located below the anti-peeping structure 1, then when the first side 123 of the anti-peeping units 12 is rotated to the bottom, the anti-peeping units 12 are in the anti-peeping mode, and only the user facing the screen can watch the images in the screen, and other people around the screen cannot watch the images in the screen. When the second side 124 of the anti-peeping unit 12 is rotated to the bottom by the drive structure 13, the anti-peeping units 12 are in the anti-peeping invalidation mode, at this time, the people within a certain angle range of the screen can watch the images in the screen.

The anti-peeping structure 1 provided in the embodiment of the present application arranges the anti-peeping units 12 in the housing 11, and the anti-peeping units 12 are driven to rotate by the drive structure 13, such that the anti-peeping units 12 can be flexibly switched between the anti-peeping mode and anti-peeping invalidation mode, which is convenient for users to use according to actual needs. In addition, the anti-peeping structure 1 is divided into the plurality of anti-peeping units 12, such that the length and width dimensions of each anti-peeping unit 12 are greatly reduced, which facilitates the anti-peeping units 12 to flip and rotate in the cavity 110 with a limited thickness to meet the requirement of flexible switching between the anti-peeping mode and the anti-peeping invalidation mode. Further, the present application also enables the anti-peeping structure 1 to have a sufficiently small thickness while being able to flexibly switch between the anti-peeping mode and the anti-peeping invalidation mode.

In the embodiment, the housing 11 can be of glass structure, which has a certain support strength, and be able to transmit light. It is understood that, in other embodiments of the present application, the housing 11 can also be made of other light-transmitting materials and is not uniquely limited here.

In one embodiment, as shown in FIG. 1, the anti-peeping structure 1 includes a plurality of drive structures 13, the number of the drive structures 13 is the same as the number of the anti-peeping units 12, and each drive structure 13 is used to drive one of the plurality of anti-peeping units 12 to rotate, so that each anti-peeping unit 12 can be switched independently. For example, a part of the anti-peeping units 12 can be switched to the anti-peeping mode, and the other part of the anti-peeping units 12 can be switched to the anti-peeping invalidation mode, so as to achieve partial anti-peeping effect. For example, the more private part of the file can be set to the anti-peeping mode, and the other parts are set to the anti-peeping invalidation mode, so as to achieve a more accurate anti-peeping effect. It is understood that in other embodiments of the present application, the number of drive structures 13 can also be provided to be less than the number of anti-peeping units 12, specifically, one drive structure 13 can be used to rotate more than one of the plurality of anti-peeping units 12 continuously distributed, for example, two, three or a row of the anti-peeping units 12 can be synchronously rotated by one drive structure 13, such that, it can not only achieve the partial anti-peeping effect, but also save the number and design cost of the drive structure 13.

In one embodiment, the drive structure 13 is also used to drive the anti-peeping units 12 to rotate so that the anti-peeping unit(s) 12 is (are) driven to stay at positions with different anti-peeping angles. The anti-peeping units 12 in the present application can not only rotate 180 degrees from the anti-peeping mode to the anti-peeping invalidation mode, but also rotate 180 degrees from the anti-peeping invalidation mode to the anti-peeping mode. In addition, the anti-peeping units 12 can also stay at any angles between the anti-peeping mode and the anti-peeping invalidation mode to achieve the control of different anti-peeping angles.

Taking FIG. 1 as an example, when the first side 123 of the anti-peeping unit 12 is set downward, the anti-peeping unit 12 is in the anti-peeping mode. When the anti-peeping unit 12 is rotated 20 degrees clockwise, the anti-peeping angle of anti-peeping unit 12 is 20 degrees, that is, only those who are tilted 20 degrees relative to the screen can watch the images in the screen, while those who are facing the screen cannot watch the images in the screen. Similarly, the anti-peeping unit 12 can also be rotated clockwise by 40 degrees, 60 degrees or 80 degrees; and the anti-peeping unit 12 can also be rotated counterclockwise by 20 degrees, 40 degrees, 60 degrees or 80 degrees to achieve different anti-peeping angles. In the embodiment, the anti-peeping angles of the anti-peeping unit 12 are controlled, so that the different anti-peeping angle requirements of the user can be met.

In one embodiment, as shown in FIG. 1, the drive structure 13 includes a plurality of electric field units 131, the plurality of electric field units 131 are arranged on the housing 11 and form an electric field in the cavity 110, and the electric field units 131 act on the anti-peeping units 12 to drive the rotating of the anti-peeping units 12. In the embodiment, the electric field units 131 are used to drive the anti-peeping units 12 respectively, and the physical space occupied by the electric field units 131 is small, which is conducive to the design of the anti-peeping structure 1 being thinner, and it is convenient to design the anti-peeping structure 1 inside the electronic display device. In addition, the electric field units 131 can be designed into multiple, so that each anti-peeping unit 12 can be independently driven to achieve partial anti-peeping effect.

The number of electric field units 131 is designed to be the same as the number of the anti-peeping units 12, and each of anti-peeping units 12 is correspondingly driven by one electric field unit 131. The anti-peeping units 12 are distributed in a matrix in the cavity 110 of the housing 11, and the electric field units 131 are located relative to the corresponding anti-peeping units 12 in the housing 11. The electric field units 131 generates an electric field parallel to the thickness direction of the housing 11, and the electric field acts on the anti-peeping unit(s) 12 and drives the anti-peeping unit(s) 12 to rotate.

Specifically, the electric field unit 131 can generate an electric field parallel to the thickness direction of the housing 11 by applying voltage to the upper and lower sides of the housing 11 through circuits formed on the upper and lower sides of the housing 11 respectively.

In one embodiment, as shown in FIG. 1 and FIG. 2, each anti-peeping unit 12 is coated with a positive electrode coating layer 132 and a negative electrode coating layer 133, the positive electrode coating layer 132 and the negative electrode coating layer 133 are respectively arranged on the first side 123 and the second side 124; and the positive electrode coating layer 132 and the negative electrode coating layer 133 are symmetrically arranged on both sides of a rotation axis of the anti-peeping unit 12, respectively. When the electric field generated by the electric field units 131 acts on the positive electrode coating layer 132 and the negative electrode coating layer 133, the electric field forms a pushing force to the positive electrode coating layer 132 and the negative electrode coating layer 133 in opposite directions respectively, so as to push the anti-peeping units 12 to rotate. When different voltages are applied to the electric field units 131, the anti-peeping units 12 can be driven to rotate in different directions to achieve different anti-peeping effects. In addition, by applying voltages of different intensities, the anti-peeping units 12 can be rotated at different angles to achieve different anti-peeping angles.

Specifically, the positive electrode coating layer 132 can be a positive electrode material coated on the surface of the anti-peeping unit 12, the negative electrode coating layer 133 can be a negative electrode material coated on the surface of the anti-peeping unit 12, and the positive electrode material and the negative electrode material are transparent electrode materials.

It is understood that in other embodiments of the present application, the anti-peeping units 12 can also be driven to rotate by forming a magnetic field in the housing 11 and providing conductors on the anti-peeping units 12 through the magnetic field acting on the conductors.

In addition, in other embodiments of the present application, the drive structure 13 can also include a plurality of rotating drive members, each of the rotating drive members is connected to and used to drive the rotating of each anti-peeping unit 12. Specifically, more that one of the plurality of anti-peeping units 12 can be connected with a same rotating shaft, and then the rotating shaft is driven by the rotating drive member, so as to drive the anti-peeping units 12 to rotate. In the embodiment, the rotating drive member can be an electrical machine or a motor, which is not uniquely limited here.

In one embodiment, as shown in FIG. 1 and FIG. 2, a plurality of shaft rods 14 are arranged in the cavity 110 of the housing 11 and are distributed sequentially at intervals, each shaft rod 14 is provided with more than one of the plurality of anti-peeping units 12, and each anti-peeping unit 12 is rotatably arranged on shaft rod 14.

Specifically, as shown in FIG. 2, the shaft rods 14 are arranged at equal intervals along a first direction X, and the shaft rods 14 are arranged parallel to each other. The shaft rods 14 are extended along a second direction Y in a straight line, opposite two ends of each shaft rod 14 along the second direction Y are fixed to the housing 11, and the first direction X and the second direction Y are perpendicular to each other. Each shaft rod 14 is covered with the anti-peeping units 12, and anti-peeping units 12 are arranged on shaft rod 14 with the center line of shaft rod 14 as the rotating axis. When the anti-peeping units 12 are driven by the electric field, the anti-peeping units 12 rotate around shaft rod 14. When the electric field corresponding to each the anti-peeping units 12 is different, each of the anti-peeping units 12 will do different rotation directions and/or rotation angles on the same shaft rod 14 to achieve different anti-peeping effects.

Generally, in the embodiment, the plurality of shaft rods 14 are provided, and each of the plurality of shaft rods 14 is used to carry a row of anti-peeping units 12, thus the installation of each anti-peeping unit 12 and the entire anti-peeping structure 1 can be simplified.

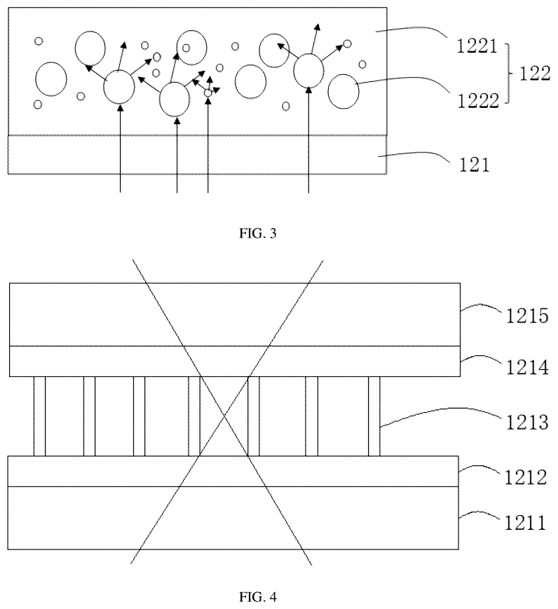

In one embodiment, as shown in FIG. 3, each of the anti-peeping units 12 includes an anti-peeping film 121 and a diffusion film 122. The diffusion film 122 is attached to one side of the anti-peeping film 121, and the anti-peeping film 121 has anti-peeping effect, and the anti-peeping film 121 controls the visible angle of light within a predetermined range, that is, after the light is transmitted to the anti-peeping film 121, it can only be seen from certain angles. The diffusion film 122 is used to diverge the light emitted into the diffusion film 122, and the light after the diffusion film 122 will be refracted, reflected and scattered out, thus destroying the anti-peeping effect of the anti-peeping film 121. When the diffusion film 122 of the anti-peeping unit 12 is placed towards the light source, the anti-peeping unit 12 is in the anti-peeping mode; when the anti-peeping film 121 of anti-peeping unit 12 is placed towards the light source, the anti-peeping unit 12 is in the anti-peeping invalidation mode.

The anti-peeping film 121 is a common film with anti-peeping effect. The anti-peeping film 121 adopts ultra-fine shutter optical technology, so that the data displayed on the screen is exclusively for users to read in front, and anyone who looks on from both sides of the screen can only see the black picture. Specifically, in a specific embodiment, as shown in FIG. 4, the anti-peeping film 121 can include a PET (Polyethylene terephthalate) layer 1211, an adhesive layer 1212, fine shutter film papers 1213, and a PC (Polycarbonate) layer 1214 and an anti-glare hard coating layer 1215, and the fine shutter film papers 1213 are successively distributed at equal intervals, when the light transmits the anti-peeping film 121, the solid line of light shown in FIG. 4 is the anti-peeping angle.

In addition, as shown in FIG. 3, the diffusion film 122 is a diffusion film 122 using PET material as the substrate 1221. Chemical particles are added to the diffusion film 122, which are used as the dispersive particles 1222, and the light will be dispersed by the dispersive particles 1222, thus removing the anti-petting effect.

It can be understood that in other embodiments of the present application, each of the anti-peeping units 12 can also include the anti-peeping film 121, and the surface of one side of the anti-peeping film 121 is formed with a concave-convex microstructure, which refracts, reflects and diverges light through the concave-convex microstructure, thereby destroying the anti-peeping effect of the anti-peeping film 121. Thus, the anti-peeping unit 12 has the anti-peeping mode and the anti-peeping invalidation mode.

As shown in FIG. 5, the present application further provides an electronic display device, which includes the above anti-peeping structure 1. By applying the anti-peeping structure 1 to the electronic display device, the electronic display device has anti-peeping effect, and can flexibly switch between the anti-peeping mode and the anti-peeping invalidation mode.

In one embodiment, as shown in FIG. 5, the electronic display device further includes a backlight light source 2 and a display module 3, and the anti-peeping structure 1 is arranged between the backlight light source 2 and the display module 3. In the present application, by embedding the anti-peeping structure 1 inside of the electronic display device, the anti-peeping structure 1 can be avoided from being damaged, and the moisture-proof effect can be achieved. In addition, it is also conducive to forming an electrical connection between the anti-peeping structure 1 and the circuit structure inside the electronic display device. It is understood that, in other embodiments of the present application, the anti-peeping structure 1 can also be located on the surface of display module 3, which is not uniquely limited here.

Specifically, as shown in FIG. 5, the backlight light source 2 includes a reflective film 21, a light source plate 22, a light guide plate and an optical film 23; and the reflecting film 21, the light source plate 22, the light guide plate and the optical film 23 are successively installed on the shell 4. The anti-peeping structure 1 is arranged on the optical film 23, and the display module 3 is bond onto the front side of the shell 4 by a foam adhesive 5.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

What is claimed is:

1. An anti-peeping structure, comprising:
a housing, the housing being a transparent structure provided with a cavity;
a plurality of anti-peeping units arranged in the cavity of the housing at intervals; and
a drive structure;
wherein each of the plurality of anti-peeping units is provided with a first side and a second side opposite to the first side, the anti-peeping unit is in an anti-peeping mode when the first side is configured to face a light source, or the anti-peeping unit is in an anti-peeping invalidation mode when the second side is configured to face the light source; and the drive structure is configured to drive each of the plurality of anti-peeping units to rotate in the cavity so as to enable the plurality of anti-peeping units to switch between the anti-peeping mode and the anti-peeping invalidation mode.

2. The anti-peeping structure according to claim 1, wherein the drive structure is further configured to drive the plurality of anti-peeping units to rotate to make the plurality of anti-peeping units to stay at positions with different anti-peeping angles.

3. The anti-peeping structure according to claim 1, wherein the anti-peeping structure comprises a plurality of drive structures, and each of the plurality of drive structures is configured to drive one of the plurality of anti-peeping units to rotate; or to drive more than one of the plurality of anti-peeping units continuously distributed to rotate.

4. The anti-peeping structure according to claim 1, wherein the drive structure comprises a plurality of electric field units, the plurality of electric field units are arranged on the housing and configured to form an electric field in the cavity, and the plurality of electric field units are acted on the plurality of anti-peeping units to drive the plurality of anti-peeping units to rotate.

5. The anti-peeping structure according to claim 4, wherein each anti-peeping unit is coated with a positive electrode coating layer and a negative electrode coating layer, the positive electrode coating layer and the negative electrode coating layer are respectively arranged on the first side and the second side; and the positive electrode coating layer and the negative electrode coating layer are symmetrically arranged on both sides of a rotation axis of the anti-peeping unit, respectively.

6. The anti-peeping structure according to claim 1, wherein the drive structure comprises a plurality of rotating drive members, each of the plurality of rotating drive members is connected to each of the plurality of anti-peeping units and configured to drive the plurality of anti-peeping units to rotate.

7. The anti-peeping structure according to claim 1, wherein a plurality of shaft rods are arranged in the cavity and spaced in sequence, each of the plurality of shaft rods is distributed with more than one of the plurality of anti-peeping units, and each of the anti-peeping units is roatably arranged on the shaft rod.

8. The anti-peeping structure according to claim 1, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

9. The anti-peeping structure according to claim 2, wherein a plurality of shaft rods are arranged in the cavity and spaced in sequence, each of the plurality of shaft rods is distributed with more than one of the plurality of anti-peeping units, and each of the anti-peeping units is roatably arranged on the shaft rod.

10. The anti-peeping structure according to claim 2, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

11. The anti-peeping structure according to claim 3, wherein a plurality of shaft rods are arranged in the cavity and spaced in sequence, each of the plurality of shaft rods is distributed with more than one of the plurality of anti-peeping units, and each of the anti-peeping units is roatably arranged on the shaft rod.

12. The anti-peeping structure according to claim 3, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

13. The anti-peeping structure according to claim 4, wherein a plurality of shaft rods are arranged in the cavity and spaced in sequence, each of the plurality of shaft rods is distributed with more than one of the plurality of anti-peeping units, and each of the anti-peeping units is roatably arranged on the shaft rod.

14. The anti-peeping structure according to claim 4, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

15. The anti-peeping structure according to claim 5, wherein a plurality of shaft rods are arranged in the cavity and spaced in sequence, each of the plurality of shaft rods is distributed with more than one of the plurality of anti-peeping units, and each of the anti-peeping units is roatably arranged on the shaft rod.

16. The anti-peeping structure according to claim 5, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

17. The anti-peeping structure according to claim 6, wherein a plurality of shaft rods are arranged in the cavity and spaced in sequence, each of the plurality of shaft rods is distributed with more than one of the plurality of anti-peeping units, and each of the anti-peeping units is rotatably arranged on the shaft rod.

18. The anti-peeping structure according to claim 6, wherein each of the plurality of anti-peeping units comprises an anti-peeping film and a diffusion film, the diffusion film is attached to one side of the anti-peeping film, the anti-peeping film is configured to control a visible angle of light within a predetermined range, and the diffusion film is configured to disperse a light emitting into the diffusion film.

19. An electronic display device, comprising an anti-peeping structure, the anti-peeping structure comprising:
a housing, being a transparent structure provided with a cavity;
a plurality of anti-peeping units, arranged in the cavity of the housing at intervals; and
a drive structure;
wherein each of the plurality of anti-peeping units is provided with a first side and a second side opposite to the first side, the anti-peeping unit is in an anti-peeping mode when the first side is configured to face a light source, or the anti-peeping unit is in an anti-peeping invalidation mode when the second side is configured to face the light source; and the drive structure is configured to drive each of the plurality of anti-peeping units to rotate in the cavity so as to enable the plurality of anti-peeping units to switch between the anti-peeping mode and the anti-peeping invalidation mode.

20. The electronic display device according to claim 19, wherein the electronic display device further comprises a backlight light source and a display module, and the anti-peeping structure is arranged between the backlight light source and the display module.
